(19) United States
(12) Patent Application Publication
(10) Pub. No.: US 2016/0103148 A1
(43) Pub. Date: Apr. 14, 2016

(54) INTUITIVE SPEEDOMETER

(71) Applicant: Elad RONEN, Rosh Haain (IL)

(72) Inventor: Elad RONEN, Rosh Haain (IL)

(21) Appl. No.: 14/894,345

(22) PCT Filed: Jun. 10, 2014
(86) PCT No.: PCT/IL2014/050518

§ 371 Date: Nov. 26, 2015

Related U.S. Application Data
(60) Provisional application No. 61/833,950, filed on Jun. 12, 2013.

(51) Int. Cl. G01P 1/08

(52) U.S. Cl. CPC G01P 1/08

(57) ABSTRACT

A vehicle speedometer, method of communicating speed to a driver, and a set of stickers for affixing to a vehicle speedometer, wherein speed is displayed in intuitive, easily understood units which indicate to a driver of the vehicle the number of meters the vehicle travels in a very short period of time such as one second.

This patent application claims the benefit of U.S. Provisional Patent Application No. 61/833,950, filed Jun. 12, 2013

### FIELD AND BACKGROUND OF THE INVENTION

The present invention relates to an intuitive vehicle speedometer which displays the vehicle's speed in non-standard units adapted to represent the distance traveled in a very short amount of time by using understandable units of measurement.

Vehicle speedometers are well known in the art. A vehicle speedometer typically consists of a speed sensor or other speed measuring instrument, and a visual gauge or display for displaying an instantaneous vehicular speed to the driver. See for example U.S. Pat. No. 2,091,025 “ELECTRIC SPEEDOMETER” which is incorporated by reference for all purposes as if fully set forth herein. However, a well known problem which is believed to heavily contribute to road accidents is a driver's inability to appreciate the significance of the link between vehicle speed and the distance which the vehicle travels in a very short amount of time, such as the time it takes to react to a sudden event. By presenting the speed data differently—in smaller and more easily understood units of measurement—at any time, the driver can easily and quickly understand the distance the vehicle travels each second. The combination of understanding the real speed and knowing the distance the car will travel before the driver has had time to react and alter the speed or direction of travel will consequently lead to better awareness and safe minded behavior at first, and prevention of hazardous actions and reducing distractions (such as cellular, radio , etc.) secondly.

However, current speedometers which typically display the vehicle speed in standard accepted units of speed measurement such as kilometers per hour (km/h) and/or miles per hour (m/h) do not assist the driver to mathematically calculate, for example, how many meters the vehicle travels in one second. Those standard units do not adequately convey to a driver how far the vehicle will necessarily travel should a sudden event require an immediate driver reaction to prevent a collision. As a result of a driver not having this information at his/her fingertips, a collision may occur which could have been prevented if the driver had been aware of his/her vehicle speed in understandable, intuitive units adapted for very short distances.

### SUMMARY OF THE INVENTION

In one embodiment, the present invention is an intuitive vehicle speedometer which indicates instantaneous vehicle speed in non-standard units which are selected as being representative of the distance the vehicle travels in a very short amount time, such as a few seconds or less. Ideally, this very short amount of time should roughly equate to an average reaction time.

Reaction time, as used herein, means the time required to effect a driving change since the onset of a sudden event. Reaction time is calculated as driver reaction time plus vehicle reaction time. Driver reaction time is the time it takes for the driver to react to a sudden event such as an impending collision and effect a change in vehicle speed or direction. Vehicle reaction time is the time it takes for the vehicle to respond to the change effected by the driver (e.g. applying the brakes to the wheel in response to a brake pedal depression, turning the wheels in response to a steering wheel rotation, etc.). We found that one second is acceptable as an estimate of average reaction time across different drivers and different vehicles.

In one embodiment, a standard-unit speedometer is adapted to display the speed in non-standard units. In one embodiment a standard-unit speedometer is fitted with decals or stickers that display the speed in non-standard units alongside the standard-units.

In another embodiment, a vehicle may be outfitted with a second, standalone speedometer which displays the speed in non-standard units only.

In one embodiment, the non-standard unit is meters, yards or feet per second. In another embodiment the non-standard unit is meters, yards or feet per reaction time, which could be 1 second (the average reaction time) or could be any other number between 0.1 seconds and 5 seconds.

According to the present invention there is provided a method of communicating to a driver of a vehicle the distance the vehicle travels over time in understandable units, the method including: displaying an instantaneous vehicle speed in an intuitive unit of speed measurement, the intuitive unit of speed measurement consisting of a time component and a distance component, where the time component is seconds and the distance component is selected from the group consisting of meters, yards and feet.

According to the present invention there is further provided a vehicle speedometer, where the speed of the vehicle is displayed in intuitive units of speed measurement, the intuitive unit of speed measurement including a time component and a distance component, the time component and the distance component being respectively chosen to indicate the actual distance the vehicle is expected to travel in a short period of time. Preferably, the short period of time is less than 5 seconds. Most preferably the short period of time is 1 second. Preferably the distance component is meters, yards or feet.

According to the present invention there is further provided a set of stickers for affixing to a vehicle speedometer wherein each of the stickers include printed matter indicative of a speed in meters per second, and wherein the set includes a direction for affixing each of said stickers on, above, or next to a vehicle speedometer so that substantially any speed indicated by the vehicle speedometer can be translated to a speed in meters per second by reference to the affixed stickers

### BRIEF DESCRIPTION OF THE DRAWINGS

Various embodiments are herein described, by way of example only, with reference to the accompanying drawings, wherein:

FIG. 1 is one embodiment of an intuitive speedometer according to the present invention;

FIG. 2 is an embodiment of a set of speedometer stickers according to the present invention;

### DESCRIPTION OF THE PREFERRED EMBODIMENTS

The principles and operation of an intuitive speedometer according to the present invention may be better understood with reference to the drawings and to the accompanying description.

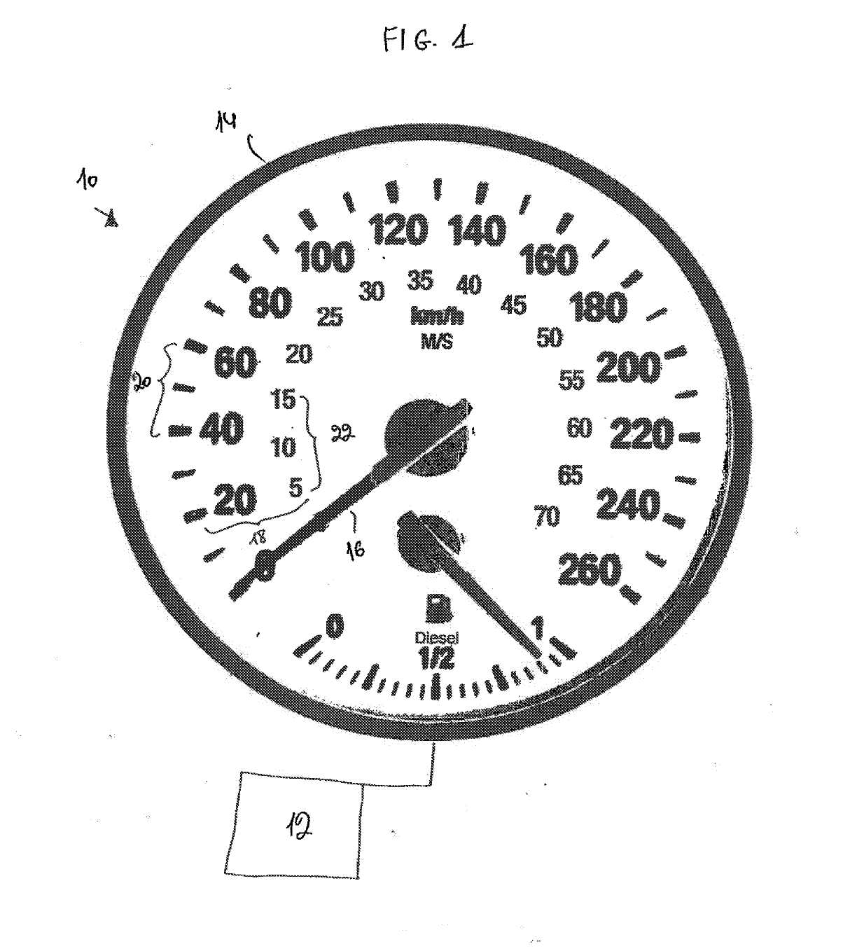

Referring now to the drawings, FIG. 1 shows an intuitive speedometer according to the present invention. Intuitive speedometer 10 consists of a speed measuring device (sensor, etc.) 12 connected to a display 14. Display 14 includes a needle 16 and a number scale 18. Number scale 18 includes a standard unit scale 20 and an intuitive unit scale 22. Standard unit scale 20 displays an instantaneous speed in km/h while intuitive unit scale 22 conveys the same information in intuitive units (m/s in FIG. 1). In FIG. 1, intuitive unit scale 22 indicates meters per one second as representative of the average reaction time across different drivers and vehicles being approximately one second. In operation, when the vehicle's instantaneous speed is, for example, 90 km/h, needle 16 will point to 90 km/h on standard unit scale 20 and 25 m/s on intuitive unit scale 22, conveying to the driver that in case of a sudden event, the distance the vehicle will travel during a reaction time of one second is 25 meters.

As will be appreciated by one skilled in the art, for any given predefined reaction time, intuitive unit scale 22 may be aligned with standard unit scale 20 to give the proper reading as a function of mathematics. For example, if the predefined reaction time is 0.5 seconds, intuitive unit scale 22 would be aligned with standard unit scale 20 so that meters per half second (instead of meters per second) on intuitive unit scale 22 correspond with speed on standard unit scale 20. For example, at 36 km/h intuitive unit scale 22 would read 5 meters per half second while at 180 km/h, 25 meters per half second would be shown. While FIG. 1 shows an analog speedometer for illustrative purposes, it should be appreciated by one skilled in the art that embodiments featuring digital speedometers (or any other speedometer type) are also possible using the principles described herein.

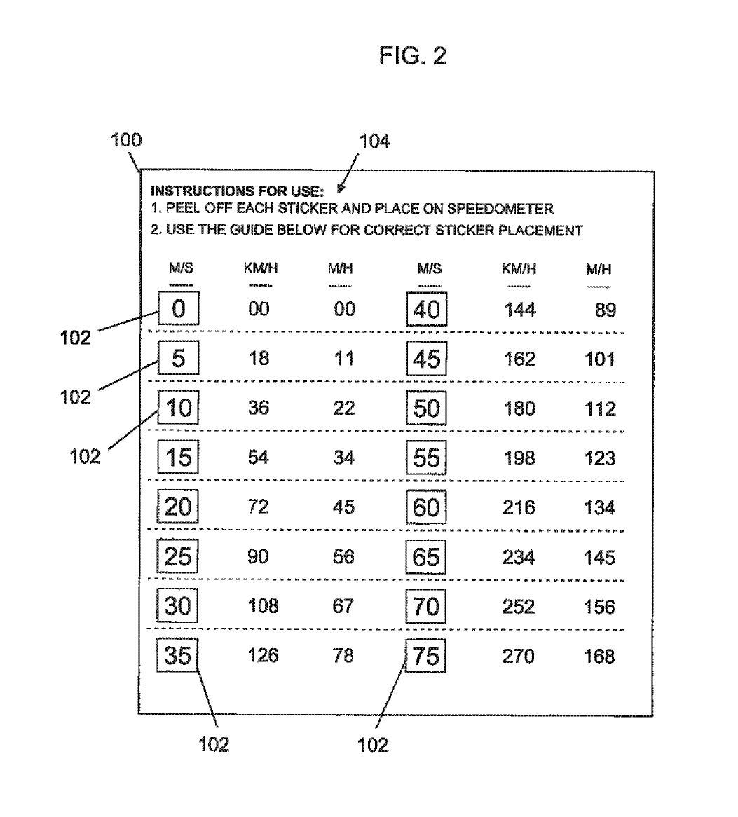

FIG. 2 illustrates a set of stickers for affixing on, over, or next to a traditional vehicle speedometer according to an embodiment of the present invention. Sticker sheet 100 contains a set of removable stickers 102, each sticker 102 being printed with a numerical speed in meters per second. Sticker sheet 100 also includes written instructions 104 directing a user as to the proper placement of each sticker 102 on (or next to) a vehicle speedometer by reference to an included guiding chart (as shown in FIG. 2) indicating, for each speed in meters per second, the equivalent speed in kilometers per hour and miles per hour.

Using the invention described herein, the driver may be immediately aware of the distance the vehicle will travel before the driver has had time to react, and can, using this information, maintain a safe vehicle speed relative to current road and traffic conditions.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of communicating to a driver of a vehicle the distance the vehicle travels over time in understandable units, the method comprising:
displaying an instantaneous vehicle speed in an intuitive unit of speed measurement, the intuitive unit of speed measurement consisting of a time component and a distance component, wherein the time component is seconds and the distance component is selected from the group consisting of meters, yards and feet.

2. A vehicle speedometer, wherein the speed of the vehicle is displayed in intuitive units of speed measurement, the intuitive unit of speed measurement consisting of a time component and a distance component, the time component and the distance component being respectively chosen to indicate the distance the vehicle travels in a short period of time.

3. The speedometer of claim 2 wherein said short period of time is less than 5 seconds.

4. The speedometer of claim 3 wherein said short period of time is 1 second.

5. The speedometer of claim 4 wherein the distance component is selected from the group consisting of meters, yards and feet.

6. The speedometer of claim 2 wherein said short period of time is an average reaction time.

7. The speedometer of claim 6 wherein the distance component is selected from the group consisting of meters, yards and feet.

8. A set of stickers for affixing to a vehicle speedometer wherein said stickers include printed matter indicative of a speed in meters per second, and wherein said set includes a direction for affixing each of said stickers on, above, or next to a vehicle speedometer so that substantially any speed indicated by said vehicle speedometer can be translated to a speed in meters per second by reference to said affixed stickers.
